(19) United States
(12) Patent Application Publication
(10) Pub. No.: US 2025/0273914 A1
(43) Pub. Date: Aug. 28, 2025

(54) PLUG CONNECTOR HOUSING HAVING A DATA DIODE FOR ELECTRONIC DATA LINES

(71) Applicant: HARTING Electric Stiftung & Co. KG, Espelkamp (DE)

(72) Inventors: Markus FRIESEN, Espelkamp (DE); Felix LOSKE, Minden (DE); Till RIECHMANN, Stemwede (DE); Marian DÜMKE, Hüllhorst (DE); Matthias FRITSCHE, Petershagen (DE); Till ZIMMERMANN, Hameln (DE); Thomas HÄNEL, Osnabrück (DE); Leonhard BRÜGEMANN, Osnabrück (DE); Nils ASCHENBRUCK, Osnabrück (DE); Kurt BETTENHAUSEN, Bischofsheim (DE)

(21) Appl. No.: 18/577,627

(22) PCT Filed: Jun. 23, 2022
(86) PCT No.: PCT/DE2022/100463

§ 371 Date: Jan. 8, 2024

(30) Foreign Application Priority Data
Jul. 6, 2021 (DE) 10 2021 117 401.5

(51) Int. Cl. H01R 13/717; G06F 21/60; H01R 13/627; H01R 13/635; H01R 13/66; H01R 31/00; H01R 31/06

(52) U.S. Cl. CPC H01R 13/7175; G06F 21/606; H01R 13/6273; H01R 13/635; H01R 13/6683; H01R 31/005; H01R 31/065; H01R 2201/04

(57) ABSTRACT

A plug connector housing for electronic data lines, comprising a data diode integrated into the plug connector housing.

The invention relates to a plug connector housing for electronic data lines.

In data networks, it is often necessary to protect certain network nodes or even entire subnetworks from unauthorized access, such as bugging operations or sabotage. In addition to so-called firewalls, which check incoming data for possible malware, the use of so-called data diodes is also considered. These data diodes are circuit elements which permit a flow of data only in one single direction, from the transmitter to the receiver, and thus represent the information technology counterpart to semiconductor diodes which permit a flow of current only in one direction.

For example, such data diodes in remote monitoring systems can be used to enable the reading of sensor data, but to block the transmission of commands to the sensors in order to protect the sensors from tampering. The same also applies, for example, to surveillance cameras.

In software development, data diodes in Brownfield scenarios can be used to connect legacy devices unidirectionally.

Another possible application is the prevention of undesirable functionalities. For example, in a printer, a data diode can be used to prevent the printer from sending information to the manufacturer, while also allowing the printer to receive print jobs and software updates.

In the interaction between man and machine, data diodes can be used to prevent external opportunities for intervention and thus to prevent danger to humans. If, for example, in a motor vehicle, a driver assistance system or a partially autonomous driving system is connected to the Internet via a data diode, the system can send emergency calls, congestion reports and the like, but it is possible to prevent someone from outside taking control of the vehicle in the event of a hacker attack.

Under certain conditions, however, it may be permissible and necessary to bypass or disconnect the data diode, for example in the event of a software update.

An example of a data diode is described in WO 2019063258 A1.

DE 10 2009 058 879 A1 describes a data diode in the form of two plug connectors which are in engagement with one one another and which together form an optical data transmission link. One of the plug connectors contains optical transmitters (LEDs) which convert electronic signals into optical signals and the complementary plug connector contains optical receivers which convert the optical signals back into electronic signals. Due to the hardware, data can only flow from the transmitter side to the receiver side.

However, communication in data networks is typically based on standardized bus systems with standardized data lines and standardized plug connectors via which electronic signals can be transmitted in both directions. The data diodes must then be implemented in the hardware of the individual network nodes.

The object of the invention is to enable a simpler and more flexible configuration of data networks with data diodes.

For this purpose, the invention provides a plug connector housing into which a data diode is integrated.

Both the input signals and the output signals of the data diode are thus electronic signals which can be transmitted via conventional bus systems. When a data network is set up or configured, the data lines are usually connected to the hardware in the network nodes using plug connectors. If a data diode is to be installed in a data line, only one of the conventional plug connectors needs to be replaced by a plug connector having the plug connector housing according to the invention into which the data diode is integrated. The hardware in the actual network nodes thus does not need to be changed.

An electrical plug connection is typically formed by two complementary plug connectors, one of which has a housing which is fixedly attached to the device which is to be connected, while the housing of the other plug connector is located at the end of a cable which forms the data line. The plug connector housing according to the invention may be either the device-side housing or the cable-side housing. If the intention for a particular device is to prevent the protection which is achieved by the data diode from being able to be offset simply by replacing the network cable, a housing with an integrated data diode will be used for the device-side plug connector. If, on the other hand, the desire is to leave open the possibility of switching flexibly between a configuration with and without a data diode, it is advisable to use a housing with a data diode for the cable-side plug connector.

Advantageous configurations and developments of the invention are specified in the dependent claims.

If a data line is formed by multi-core cables and multi-pole plug connectors and thus has a plurality of mutually independent communication channels, the data diode which is integrated into the plug connector housing may also be a multi-channel diode which in each individual channel only allows a flow of information in one direction. In this case, however, the forward direction may in principle be different from channel to channel.

The single-channel or multi-channel data diodes may optionally be designed as hard diodes or as soft diodes. In the case of a hard diode, the hardware, for example by means of an optical data transmission link, ensures that the communication can only take place in one direction. In the case of a soft diode, on the other hand, the same functionality is achieved by software.

Many common bus systems and communication protocols require bidirectional communication at least occasionally, for example when establishing a connection. Error correction algorithms, which require bidirectional communication so that, in the case of defective data packets, retransmission of the same data packet can be requested, are also often implemented. In such cases, both the input and output sides of the data diode have a proxy which emulates the bidirectional communication. If necessary, a greater susceptibility to error must be accepted in this case. However, this problem can at least be mitigated by the use of forward error protection algorithms. Such an error protection algorithm can make provision, for example, for the redundancy to be increased, for example by “preventively” transmitting multiple times each data packet which is to be transmitted.

The functionality of the proxies must be adapted to the communication protocol which is to be used in each case. For this purpose, the data diode may have a configuration file in which the emulation algorithms and/or the protocol specifications are stored in advance. The data diode may also optionally have a configuration interface via which the content of the configuration file can be subsequently changed.

The configuration interface can also be used for other purposes, for example to activate and deactivate the data diode depending on the situation or to reverse the forward direction. However, for security reasons, the commands transmitted from the outside to the communication interface should be encrypted. In addition, the data diode then requires a key file which makes it possible to decrypt the commands. As an alternative, it is also conceivable to provide on the plug connector housing a switch, preferably a key switch, using which it is possible to manually switch over between different configurations or forward directions or operating modes.

Optionally, learning software, which can be used to learn the protocol-dependent emulation algorithms, can also be implemented in the data diode. In a learning mode, the data diode can then be disconnected so that true bidirectional communication takes place, which is tracked by the learning software. In this case, the software learns how the signals transmitted by the communication partners must be answered in accordance with the protocol. After completing the learning phase, the software is then able to emulate the protocol when the data diode is active.

Some of the functionalities described above may also be generally advantageous in data diodes, regardless of whether or not the diode is integrated into a plug connector housing.

Therefore, a data diode, characterized by a configuration interface, using which the data diode can be switched over between different operating modes, in particular between an active and an inactive state and/or between opposite forward directions, is also disclosed.

Also disclosed is a data diode having input-side and output-side proxies for emulating bidirectional communication protocols, characterized in that learning software, which is able to learn emulation, in accordance with protocol, of bidirectional communication through observation of real bidirectional communication, is implemented in the data diode.

The invention further relates to an electrical plug connector having an arrangement of electrical contacts on or in a plug connector housing, characterized in that a data diode is integrated into the plug connector housing.

The invention moreover relates to a plug connector system having a plurality of mutually complementary plug connectors in pairs, at least one of which comprises a housing having an integrated data diode.

Exemplary embodiments are explained in more detail hereinafter by way of the drawing.

In the figures:

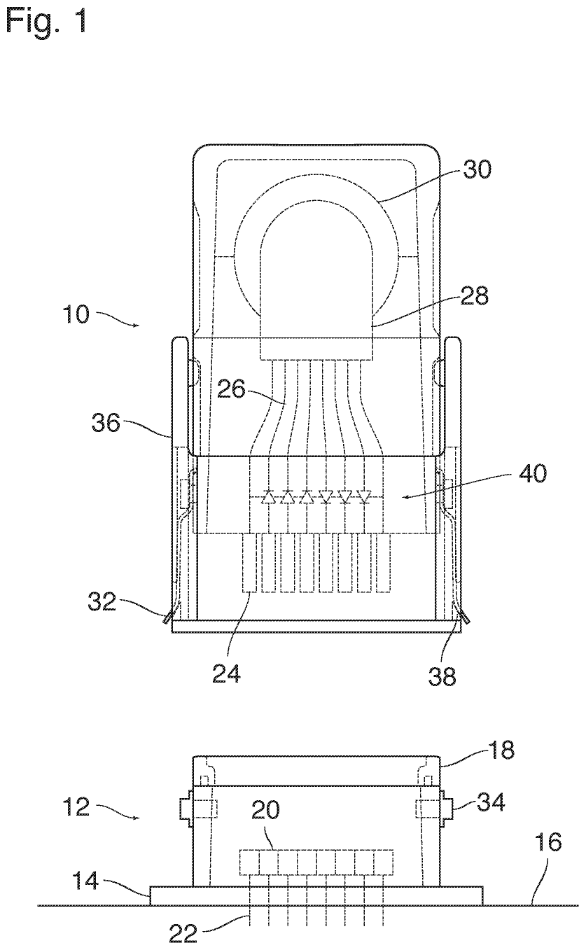

FIG. 1. shows an exploded illustration of a plug connector system having a plug connector housing according to the invention and a plug connector housing complementary thereto;

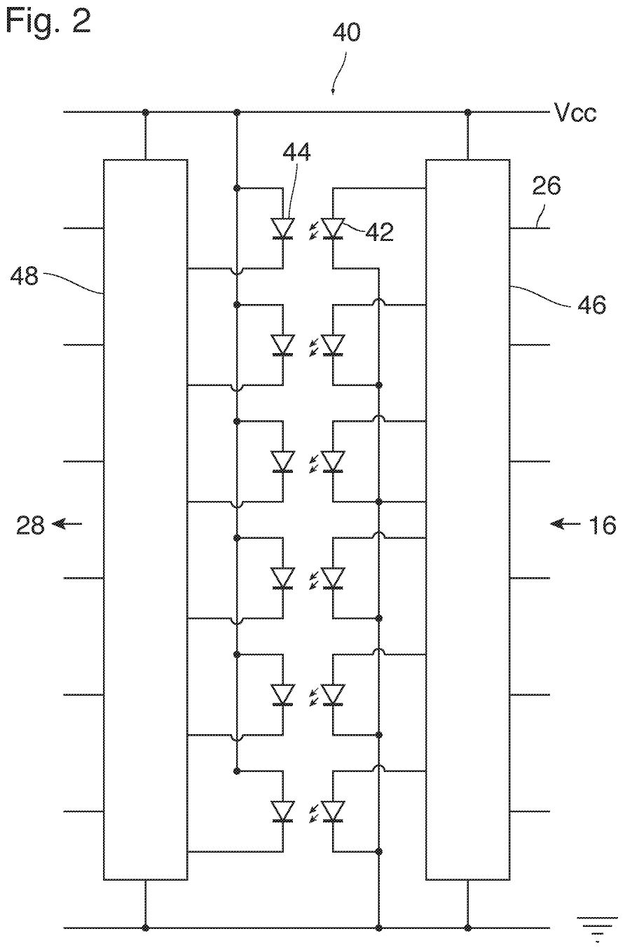

FIG. 2 shows a schematic circuit diagram of a hard data diode;

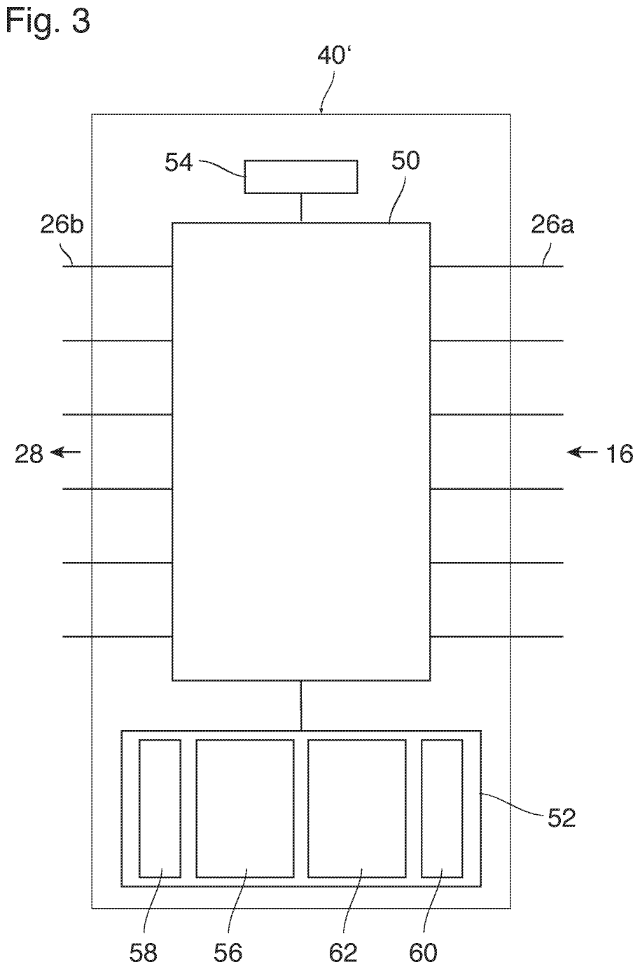

FIG. 3 shows a block diagram of a soft data diode;

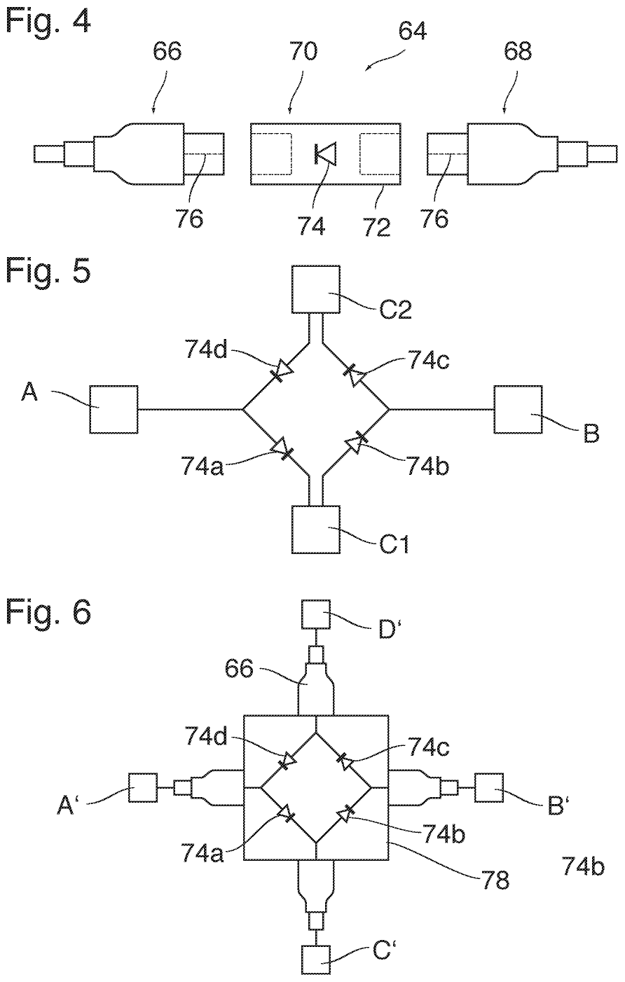

FIG. 4 shows a plug connector system having two identical plug connectors and a coupling;

FIG. 5 shows an example of a data network with data diodes; and

FIG. 6 shows a plug connector system having a plug connector housing in the form of a railroad switch having a plurality of data diodes.

FIG. 1 shows a plug connector system having two plug connector housings 10, 12. which are referred to in the following text as housings for short. The housing 12 is designed as an add-on housing and has a mounting flange 14 on the underside, by way of which mounting flange said housing is mounted on the outside of a wall of a device 16 which has electronic components, which are not shown. On the side opposite the mounting flange 14, the housing 12 has a circumferential seal 18 which surrounds an upper opening of the housing.

Inside the housing 12, there is arranged a series of electrical contacts 20, from each of which an electrical conductor 22 leads. The conductors 22 are routed through the wall of the device 16 in an insulated manner and each connected to one of the mentioned electronic components.

The upper housing 10 in FIG. 1 is in the form of a hood and can be placed by way of its lower edge onto the seal 18 of the housing 12. On its underside, the housing 10 has a series of downward projecting electrical contacts 24 which are complementary to the contacts 20 of the housing 12. An electrical conductor 26 also leads from each of the contacts 24 of the housing 10. These conductors 26 are bundled in the upper part of the housing 10 to form a cable 28 which is led out of the housing through a cable bushing 30.

In its lower region, the housing 10 has on the outside a plurality of downward projecting locking springs 32. When the housing 10 is placed onto the seal 18 of the housing 12. the locking springs 32 slide onto locking tabs 34 of the housing 12, as a result of which the two housings are locked against each other.

In addition, the lower part of the housing 10 is surrounded by an unlocking ring 36 which is guided so as to be displaceable axially (vertically) on the walls of the housing 10 and surrounds most of the locking springs 32 in the manner of a skirt. Formed on the inside of this locking ring are unlocking slopes 38 which, in the state shown in FIG. 1, engage with the outwardly exposed lower edges of the locking springs 32 and hold them in a spread position. When the unlocking ring 36 is moved to its lower position, the unlocking slopes 38 release the locking springs 32 so that they can latch onto the locking tabs 34. When the lock is to be released, the unlocking ring 36 is raised again so that the locking springs 32 are released from the locking tabs 34 again and the housing 10 can then be pulled upward.

When the housing 10 is placed onto the housing 12 and locked to it, the plug-like contacts 24 of the housing 10 enter the socket-like contacts 20 of the housing 12 and electrically conductive connections are established between the conductors 22 and 26 with the result that a multi-channel data line is created. In the example shown, there are a total of eight pairs of conductors 22, 26. Of the two outer conductor pairs, one serves as a ground conductor and the other pair is provided with a supply voltage for the electrical components of the device 16 and/or electrical components at the other end of the cable 28. The six inner pairs of conductors 22, 26 form a six-channel data line.

According to the invention, a data diode 40 is integrated into the housing 10, this being shown only symbolically in FIG. 1. In the example shown, this data diode 40 has six channels, one for each channel of the data line. In each of the six channels. the data diode 40 permits only a flow of data in one single direction. However, the forward direction of the data diode may differ from channel to channel in this case.

In the example shown, the data diode permits in three channels a flow of data from the device 16 to the cable 28 and in the three remaining channels only a flow of data from the cable 28 to the device 16. As an example, it can be assumed that the three left-hand data channels in FIG. 1 are channels via which sensor data from sensors in the device 16 are transmitted via the cable 28. In these channels, the data diode 40 prevents any commands from being transmitted to the sensors via the cable 28 in order to manipulate the sensors. The three other data channels can be used, for example, to transmit commands or data to the device 16. In these channels, the data diode 40 prevents the device 16 from being able to use these channels for data transmission.

FIG. 2 shows a possible technical implementation of the data diode 40. In this example, the data diode is designed as a hard data diode which has for each data channel one pair composed of an optical transmitter 42 (LED) and an optical receiver 44 (photodiode or CCD). The optical transmitter 42 converts electronic data signals into optical signals which are received by the receiver 44 and are converted back into electronic signals, with the result that a flow of data is only possible from the transmitter side to the receiver side. In the example shown in FIG. 2, the data diode is configured so that the flow of data on all six channels can only be effected from the side of the device 16 to the side of the cable 28.

On the input side, the data diode 40 has a proxy 46, that is to say a processor, which receives and processes the incoming signals on the lines 24 and returns signals to the device 16 via these lines 24 in accordance with a communication protocol defined for the data line. For “normal” bidirectional communication between the device 16 and a counterpart station at the other end of the cable 28, the protocol provides for a dialog between the participating entities which proceeds according to certain rules. The purpose of the data diode 40 is to prevent bidirectional communication and thus inevitably also prevents the establishment of the protocol-compliant dialog. Therefore, the proxy 46 must emulate the protocol by in each case reporting back to the device 16 the signals expected by the device according to the protocol.

On the output side, the data diode 40 has another proxy 48 which emulates the bidirectional communication for the counterpart station.

The topmost of the lines 24 in FIG. 2 carries a supply voltage Vcc for the proxies 46, 48 and the bottommost of the lines 24 serves as a ground line. When the data connection is established according to the protocol, the proxy 46 converts the digital signals arriving on the input channels into driver signals for the optical transmitters 42. With each pulse of a driver signal, a current flows through the diode, which forms the transmitter 42, to the ground conductor and the diode emits a light pulse which is received by the receiver 44. The diodes which form the optical receivers 44 are connected to the supply voltage and, when an optical pulse arrives from the transmitter 42, become temporarily conductive, with the result that an electrical pulse at the magnitude of the supply voltage Vcc is transmitted to a corresponding input of the proxy 48. These pulses are converted by the proxy 48 back into digital signals which correspond to the signals received by the proxy 46 and are forwarded via the cable 28.

FIG. 3 shows as a further example a data diode 40′ which is designed as a soft data diode. The data diode 40′ is also integrated into a plug connector housing, for example the housing 10 according to FIG. 1, and is essentially formed by a processor 50, a memory 52 and a configuration interface 54. As an example, it is again assumed that the data diode 40′ has six data channels with a uniform forward direction from the device 16 to the cable 28. The processor 50 has inputs for six input lines 26a, which are connected to the contacts 24 in FIG. 1, and outputs for six output lines 26b, which are wires of the cable 28. One of several memory blocks of the memory 52 is a program memory 56 in which operating software for the processor 50 is stored. This operating software includes on the one hand instructions for the handling of the signals on the input and output lines 26a. 26b, which ensures that no data is transmitted from the output lines 26b to the input lines 26a. On the other hand, the software includes emulation algorithms for emulating bidirectional communication according to the respective protocol or bus system, for example Internet, RS485, CAN, KMX or similar.

The configuration interface 54 makes it possible to configure the data diode for different protocols or bus systems. This communication interface 54 may be formed. for example, by a cable connection or also by a wireless connection such as Bluetooth. RFID or the like. According to a further embodiment, the configuration interface 54 has a modulator/demodulator for reading configuration commands which have been modulated from the device 16 or from the counterpart station onto the supply voltage line (powerline communication).

For security reasons, the configuration commands should be encrypted, especially when they are transmitted wirelessly or through powerline communication. A key file 58 which contains a key specific to the data diode for decrypting the configuration commands is then stored in the memory 52. This ensures that the configuration of the data diode can be changed only with the correct key. As an alternative, an authentication algorithm can also be implemented in the configuration interface.

The memory 52 furthermore contains a configuration file 60 in which the specifications for the respective valid configuration are stored, in particular the specifications of the protocol or bus system. In one embodiment, the configuration file 60 may also contain registers which specify different operating modes of the data diode, for example an active mode in which only bidirectional communication is possible and an inactive mode in which the processor 50 permits data transfers in both directions. The diode can thus be activated and deactivated by changing the content of this register via the communication interface 54. For example, the data diode can be temporarily deactivated in order to update software on a device protected by the diode. The data diode is then reactivated so that the device is again protected against external interference.

In addition, the configuration file 60 may contain registers which independently specify the current forward direction for each of the communication channels. Configuration commands which change the content of this register may thus allow the forward direction of the diode to be switched over as required by the personnel with the necessary key.

Situations are also conceivable in which the data diode 40′ is used in an environment in which even the persons authorized to configure the diode are not fully aware of the protocol or bus specifications, with the result that the configuration of the diode is difficult. In this case, the memory 52 in the example shown here contains another memory block in which learning software 62 is stored. If the protocol specifications are not fully known, a learning phase first takes place when the system is configured, in which the data diode is disconnected, that is to say bidirectional communication is possible. In this phase, therefore, communication does not need to be emulated, but the dialog is carried out in the device 16 and the counterpart station autonomously by the agents involved. However, the learning software 62 enables the processor 50 to listen to this communication and in this way, over time, to determine which responses to which requests must follow. This information is then automatically stored in the configuration file 60 with the result that the system configures itself. When the learning phase is complete, the data diode is activated and protocol-compliant communication will be emulated in future communication processes.

Forward error protection algorithms can also be implemented in the emulation software in a known manner, these algorithms preventing an increase in the error rate, which could otherwise arise due to the fact that requests cannot be made of faulty data blocks from the recipient side.

FIG. 4 shows an example of a plug connector system 64 having two identically designed plug connectors 66, 68 and a coupling 70 which is complementary to the plug connectors 66 and 68 and thus makes it possible to connect the two plug connectors together and to create a continuous data line. The coupling 70 has a plug connector housing 72 into which a data diode 74 is integrated. The data diode 74 may be either a hard diode or a soft diode. The plug connector housing 72 may contain a battery which provides the operating voltage for the data diode 74.

In the example shown, the data diode 74 draws its operating voltage via ground contacts and operating voltage contacts 76 of the plug connectors 66, 68. As an example, it can be assumed that each of these plug connectors has two parallel rows of contact pins and that the two contacts 76 (one for ground and one for operating voltage) are each in the middle of the row of contact pins. Under these circumstances, it is possible to reverse the forward direction of the data diode 74 by virtue of the entire coupling 70 being inserted between the plug connectors 66, 68 in a position rotated by 180° so that the flow of data no longer goes from 68 to 66 but from 66 to 68.

If the data diode 74 is to be completely deactivated, this can be done in smaller plug connector housings 72 by simply replacing the entire coupling 70 with a coupling without a data diode. In larger plug connector housings 72, it is also possible to provide a key switch which can be used to disconnect the data diode.

With couplings 70 of the type shown in FIG. 4 and/or with data diodes which are integrated into the housings of the plug connectors 66, 68 or of complementary plug connectors, complex data networks can be configured in a flexible manner such that certain protective purposes can be fulfilled.

FIG. 5 shows, as a simple example, a data network with nodes A, B, C1 and C2 which communicate via data diodes 74a-d which are arranged in the manner of a rectifier. By way of example, node A may be a protected company computer and node B may be an unsecure website. Nodes C1 and C2 are control entities which are operated by the company. The control entity C1 can receive data from node A at an input port via the data diode 74a and can send this data to node B via a separate output port and the data diode 74b. In contrast, direct communication from A to B via the diodes 74. 74b is not possible. By way of example, the monitoring entity C1 may be a computer which automatically checks the data sent by A for classified data contents and forwards only the unclassified data to node B. The diode 74a prevents C1 from being able to change the state of A and the diode 74b prevents B from being able to manipulate the monitoring entity.

The monitoring entity C2 can receive data from node B at an input port via the diode 74c and can send this data to node A via a separate output port and the diode 74d. By way of example, the monitoring entity C2 may be a firewall which checks the incoming data from B for any malicious software and forwards only the data which has no malicious software to A. The diode 74c prevents B from being able to receive any data from the monitoring entity or from node A and the diode 74d prevents A from being able to change the firewall configuration.

FIG. 6 shows an example of a network having a plug connector housing 78 in the form of a railroad switch which is connected via four plug connectors 66 to nodes A′, B′, C′ and D′. Integrated into the plug connector housing 78 are also four data diodes 74a-d which are connected in the manner of a rectifier but this time with a direct connection between the output of the diode 74a and the input of the diode 74b and between the output of the diode 74c and the input of the diode 74d. The diodes thus enable bidirectional communication between nodes A′ and B′. Node C′ can listen to the communication from A′ to B′ and send its own data to B′ but cannot affect A′. Conversely, node D′ can listen to the communication from B′ to A′ and send its own data to A′ but cannot affect B′.

1. A plug connector housing for electronic data lines, comprising: a data diode integrated into the plug connector housing.

2. The plug connector housing as claimed in claim 1, wherein the data diode has a plurality of parallel communication channels and, in at least one of these communication channels, only permits a flow of data in one direction.

3. The plug connector housing as claimed in claim 2. wherein the data diode contains a plurality of individual diodes in the plurality of communication channels and the forward directions of the individual diodes are configured or able to be configured independently of one another.

4. The plug connector housing as claimed in claim 1, wherein the data diode is a hard data diode, the hardware configuration of which defines the forward direction of the diode.

5. The plug connector housing as claimed in claim 1, wherein the data diode is a soft data diode, in which the forward direction is defined by the configuration of the diode software.

6. The plug connector housing as claimed in claim 1, wherein the data diode is designed to emulate bidirectional communication according to a predetermined protocol.

7. The plug connector housing as claimed in claim 1, wherein the data diode has a configuration interface for receiving configuration commands, wherein the data diode is configurable for different operating modes.

8. The plug connector housing as claimed in claim 7, wherein the data diode contains a key file with a key to decrypt encrypted configuration commands.

9. The plug connector housing as claimed in claim 7, wherein the operating modes of the data diode comprise an inactive mode in which bidirectional communication is permitted.

10. The plug connector housing as claimed in claim 7, wherein the operating modes differ in the forward direction of the data diode in at least one communication channel.

11. The plug connector housing as claimed in claim 6, wherein the operating modes differ in protocol specifications on the basis of which the bidirectional communication is emulated.

12. The plug connector housing as claimed in claim 11, wherein learning software, which is configured to learn emulation algorithms for emulating bidirectional communication when the data diode is active through observation of real bidirectional communication, is implemented in the data diode.

13. A plug connector having a plug connector housing as claimed in claim 1.

14. A plug connector system having at least two mutually complementary plug connectors, at least one of which has a plug connector housing as claimed in claim 1.

15. The plug connector system as claimed in claim 14, wherein at least one coupling, the housing of which contains the data diode and is able to be used in two opposite orientations between two plug connectors, wherein the opposite orientations determine the respective forward direction of the data diode.
